(19) United States
(12) Patent Application Publication
(10) Pub. No.: US 2023/0384494 A1
(43) Pub. Date: Nov. 30, 2023

(54) DIFFRACTION GRATING SYSTEMS

(71) Applicant: Wasatch Photonics, Inc., Logan, UT (US)

(72) Inventor: Elroy Louis Pearson, Twin Lakes, WI (US)

(21) Appl. No.: 17/861,812

(22) Filed: Jul. 11, 2022

(51) Int. Cl. G02B 5/18; G02B 5/32; G02B 5/30

(52) U.S. Cl. CPC G02B 5/1814; G02B 5/32; G02B 5/3025

(57) ABSTRACT

A diffraction system includes a first diffraction grating separated from a second diffraction grating by a waveplate. Both the first diffraction grating and the second diffraction grating have a high diffraction efficiency for a first light polarization and a low diffraction efficiency for a second light polarization. Incident light passed through the first diffraction grating is rotated by the waveplate. The diffracted light changes from the first polarization to the second polarization and passes through the second diffraction grating largely undiffracted. The light passed through the first diffraction grating changes from the second polarization to the first polarization and is diffracted by the second diffraction grating.

### CROSS-REFERENCE TO RELATED APPLICATIONS

N/A.

### BACKGROUND

Diffraction gratings are commonly used as dispersive elements in a wide range of scientific and engineering applications including spectroscopy, Dense Wavelength Division Multiplexing (DWDM) in telecommunications, and laser pulse compression. For many of these applications, having high levels of dispersion as well as good diffraction efficiency in both s (e.g., transverse-electric (Te)) and p (e.g., transverse-magnetic (Tm)) polarizations improves system performance. Additionally, some applications require low levels of difference between s polarization diffraction efficiency and p polarization diffraction efficiency, which may be characterized as Polarization Dependent Loss (PDL). However, high dispersion diffraction gratings may have a high PDL.

Two of the diffraction grating specifications that optical designers consider when designing a diffraction system include the peak diffraction efficiency and spectral bandwidth of the grating. Because diffraction gratings may be resonant optical structures, diffraction efficiency may peak at a central wavelength and then decrease the further the incident light is from that wavelength.

### SUMMARY

One aspect of the present disclosure is directed to a diffraction grating system that includes a first diffraction grating having a first diffraction efficiency in a first polarization and a second diffraction efficiency in a second polarization. The first diffraction efficiency is higher than the second diffraction efficiency. The diffraction grating system also includes a second diffraction grating and a polarization rotation medium located between the first diffraction grating and the second diffraction grating. The polarization rotation medium is configured to rotate light passed through the first diffraction grating between the first polarization and the second polarization.

In some embodiments, the first diffraction grating can be identical to the second diffraction grating.

In some embodiments, the first diffraction efficiency can be greater than 99%.

In some embodiments, a system polarization dependent loss of the system can be less than 1%.

In some embodiments, a grating polarization dependent loss of the first diffraction grating can be greater than 95%.

In some embodiments, the polarization rotation medium can be connected to the first diffraction grating with an adhesive.

In some embodiments, the polarization rotation medium can be offset from at least one of the first diffraction grating or the second diffraction grating.

In some embodiments, a gap between the polarization rotation medium and the first diffraction grating can be filled with a fluid.

In some embodiments, the first diffraction grating can be formed from a volume phase holographic grating.

In some embodiments, the first diffraction grating can include one or more surface relief structures.

Another aspect of the present disclosure is directed to a method for light diffraction. The method includes passing an incident light through a first diffraction grating. The first diffraction grating has a first diffraction efficiency with respect to a first light polarization and a second diffraction efficiency with respect to a second light polarization. Passing the incident light through the first diffraction grating includes diffracting a first light segment of the incident light with the first diffraction grating, passing a second light segment of the incident light through the first diffraction grating undiffracted, rotating the first light segment and the second light segment through a waveplate such that a polarization of the first light segment and the second light segment is changed, and passing the first light segment and the second light segment through a second diffraction grating.

In some embodiments, passing the first light segment through the second diffraction grating can include passing the first light segment through the second diffraction grating largely undiffracted.

In some embodiments, passing the second light segment through the second diffraction grating can include diffracting a large portion of the second light segment with the first diffraction efficiency.

In some embodiments, the waveplate can be a half-wave plate.

In some embodiments, the method can additionally include collecting at least 98% of the incident light at a detector.

In some embodiments, the first diffraction grating can be identical to the second diffraction grating.

Another aspect of the present disclosure is directed to a diffraction system that includes an incident light source and a diffraction grating having first diffraction efficiency in a first polarization plane and second diffraction efficiency in a second polarization plane. The first diffraction efficiency is greater than the second diffraction efficiency. The diffraction system also includes a waveplate that rotates light passed through the diffraction grating, a mirror located opposite the diffraction grating across the waveplate that reflects light back to the diffraction grating, and a light detector.

In some embodiments, the diffraction grating can be asymmetric.

In some embodiments, the light detector can be located on the same side of the waveplate as the diffraction grating.

In some embodiments, the waveplate can be a quarter-wave plate.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 is a schematic view of a diffraction system, according to at least one embodiment of the present disclosure;

FIG. 2 is an exploded view of a diffraction system, according to at least one embodiment of the present disclosure;

FIG. 3 is an index modulation profile for a diffraction grating for both s-polarized light and p-polarized light, according to at least one embodiment of the present disclosure;

FIG. 4 is a representation of the diffraction efficiency for a diffraction system for both s-polarized light and p-polarized light, according to at least one embodiment of the present disclosure;

FIG. 5 is a representation of a diffraction system, according to at least one embodiment of the present disclosure;

FIG. 6 is a representation of another diffraction system, according to at least one embodiment of the present disclosure;

FIG. 7 is a representation of yet another diffraction system, according to at least one embodiment of the present disclosure;

FIG. 8 is a representation of still another diffraction system, according to at least one embodiment of the present disclosure;

FIG. 9 is a representation of a diffraction system having a single diffraction grating, according to at least one embodiment of the present disclosure; and

FIG. 10 is a flowchart of a method for diffracting light, according to at least one embodiment of the present disclosure.

### DETAILED DESCRIPTION

This application relates to devices, systems, and methods for a diffraction grating system that has a high diffraction efficiency in both p-polarization (e.g., transverse magnetic (Tm)) and s-polarization (e.g., transverse electric (Te)). A waveplate may be placed between two diffraction gratings. When incident light passes through the first diffraction grating, the diffraction grating may diffract with a high efficiency s-polarized light and pass through (e.g., diffract with a low efficiency) p-polarized light. After the light passes through the first diffraction grating, the waveplate may rotate the polarity of the light. Thus, the s-polarized light may be rotated to p-polarized light and the p-polarized light may be rotated to s-polarized light. The second diffraction grating may be the same as the first diffraction grating, and may diffract with a high efficiency the rotated s-polarized light and pass through the rotated p-polarized light. In this manner, both the s-polarized light and the p-polarized light may be diffracted with a high efficiency.

The present disclosure includes a number of practical applications that provide benefits and/or solve problems associated with diffraction and other light dispersion systems. For example, as will be discussed in further detail herein, embodiments according to the present disclosure may allow for a high diffraction efficiency in multiple polarizations. In some situations, a dispersive element, such as a diffraction grating, may have different diffraction efficiencies for different types of light polarization. A first diffraction efficiency for a first light polarization may be higher than a second diffraction efficiency for a second light polarization. A technician may choose a dispersive element based on the difference in diffraction efficiencies for a given application. However, this may result in inefficient diffraction of the incident light, leading to reduced effectiveness of the application. By rotating the light with a waveplate between two gratings, a high diffraction efficiency may be achieved for each polarization. This may result in a highly efficient diffraction system that may be tailored to a specific application.

In accordance with embodiments of the present disclosure, a polarization rotation medium may be any optical medium that may cause a rotation in the polarization of a light beam. For example, a polarization rotation medium may be a waveplate. A quarter-waveplate may rotate the polarization halfway between S and P polarized light. A half-waveplate may rotate the polarization from S to P polarized light.

In accordance with embodiments of the present disclosure, a dispersive element may be an element that diffracts a light beam. For example, a dispersive element may be a diffraction grating. While embodiments of the present disclosure may discuss diffraction gratings, it should be understood that the principles discussed herein may be applied to any other type of dispersive elements.

In accordance with embodiments of the present disclosure, a diffraction grating may use constructive and destructive interference to spatially separate polychromatic light into component wavelengths. One type of diffraction grating is a surface-relief diffraction grating. A surface-relief diffraction grating may include an optical surface that has surface features (such as equally spaced grooves) cut into the optical surface.

Another type of diffraction grating is a volume phase holographic grating (VPHG). A VPHG may not include any surface features. Instead, a VPHG may diffract light using index modulation. A VPHG may have an index modulation profile having a particular shape, such as a sinusoidal, a truncated sinusoidal, or a square wave. In other designs, a VPHG may include secondary surface relief structures that are not primary contributors to diffractive performance of the VPHG. A VPHG may include regions having a higher index of refraction than other regions of the VPHG. For example, a VPHG may include a set of repeating structures known as Bragg planes that diffract light. The Bragg planes may have a higher index of refraction than regions in between the Bragg planes. A VPHG may have a bulk index, which may be an average of the index of refraction of the Bragg planes and the index of refraction of the regions in between the Bragg planes. A VPHG may have an index modulation, which may be a difference between the index of refraction of the Bragg planes and the index of refraction of the regions in between the Bragg planes.

The orientation of the Bragg planes may impact certain characteristics of the VPHG. For example, the Bragg planes may be oriented such that the VPHG is a symmetric grating. A symmetric grating diffracts a central wavelength at a first angle relative to the substrate normal (an angle of diffraction or AOD) that is the same as a second angle (an angle of incidence (AOI)) at which incoming light is incident to the grating. Tilting the Bragg planes may result in a VPHG that is non-symmetric. A non-symmetric grating diffracts a central wavelength at a first angle relative to the substrate normal that is different from a second angle at which light is incident to the grating.

In some embodiments, the VPHG may be a transmissive or transmission grating. In other designs, the VPHG may be a reflection or reflective grating. Transmissive VPHGs may allow low PDL, high diffraction efficiency, and high dispersion. A VPHG may not include any surface grooves or otherwise require any surface relief to diffract incident light. Instead, a VPHG may diffract light using refractive index modulations. A VPHG may have a sinusoidal index modulation profile, a truncated sinusoidal index modulation profile, a square wave index modulation profile, or an index modulation profile with a different shape.

In some embodiments, a VPHG may include secondary surface relief structures on a surface of the VPHG. The secondary surface relief structures may not be a primary contributor to diffractive performance of the VPHG. A VPHG may use sequential blazed surface relief gratings. The VPHG may include a thin layer of material (a medium) that includes alternating regions having different indexes of refraction. Specifically, along a length of the VPHG, regions having high indexes of refraction (which may be Bragg planes) may be followed by regions having lower indexes of refraction. The VPHG may have a bulk index and an index modulation. Depending on the index modulation of a VPHG, the VPHG may have a lower polarization dependence than a surface-relief grating. A VPHG may be manufactured by exposing a medium (such as photo-thermo-refractive glass) to an interference pattern from an ultraviolet laser.

In designing an optical spectrometer that includes a VPHG, a designer may consider several VPHG specifications or operating characteristics, such as a peak diffraction efficiency of the VPHG and, relatedly, a wavelength at which the peak diffraction efficiency occurs. Diffraction efficiency may be a measure of power throughput. Diffraction efficiency may be a measure of how much optical power is diffracted into one or more particular directions compared to an amount of optical power incident on a diffractive element. Diffraction efficiency may compare light that is diffracted in any direction to total incident light. In the alternative, diffraction efficiency may compare incident light that is diffracted into a first spatial diffraction order to total incident light.

In some embodiments, the diffraction efficiency of the VPHG may be a measure of an amount of light that is diffracted by the diffraction element compared to an amount of light incident on the diffraction element. The diffraction efficiency may be measured as a ratio or a percentage. The diffraction efficiency may compare total diffracted power to total incident power. Alternatively, the diffraction efficiency may compare diffracted power in a first order to total incident power. The diffraction efficiency of the diffraction element may vary based on a wavelength of incident light. In other words, the diffraction element may have a first diffraction efficiency for a first wavelength but may have a second, different diffraction efficiency for a second wavelength that is different from the first wavelength. The diffraction efficiency of the diffraction element may vary based on polarization of incident light.

The diffraction element may have a peak diffraction efficiency. The peak diffraction efficiency may be the highest diffraction efficiency of the diffraction element. The peak diffraction efficiency may occur at a particular wavelength. The diffraction efficiency of the diffraction element may be less than the peak diffraction efficiency for all wavelengths other than the particular wavelength. In the alternative, a peak diffraction efficiency may occur when a diffraction efficiency of the diffraction element at a particular wavelength is higher than diffraction efficiencies of wavelengths adjacent to the particular wavelength. In this case, the diffraction element may have more than one peak diffraction efficiency.

The diffraction efficiency of a diffractive element may vary based on a wavelength of incident light. In other words, diffraction efficiency of a diffractive element may be a function of wavelength. The peak diffraction efficiency of a diffractive element may refer to the highest diffraction efficiency of the diffractive element for a given range of wavelengths. The peak diffraction efficiency may occur at a particular wavelength. For example, a VPHG may have a peak diffraction efficiency of 99% at 1545 nm. Diffraction efficiency may depend on a polarization of incident light. The wavelength at which the peak diffraction efficiency occurs and the value of the peak diffraction efficiency may impact a spectral bandwidth of the VPHG. The total diffraction efficiency for a diffractive element may be the polarization dependent loss (PDL). The PDL may be the difference between s-polarization efficiency and p-polarization efficiency. Some applications may utilize a diffraction element that has a low PDL. However, as discussed herein, many high dispersion diffraction gratings have a high PDL (e.g., a large difference in diffraction efficiency between s and p polarizations).

In some embodiments, the diffraction efficiency characteristics of a VPHG may change based on an angle of incidence of incident light. A VPHG may have a peak diffraction efficiency, a wavelength at which the peak diffraction efficiency occurs, and a bandwidth. Adjusting a thickness and index modulation of the medium of the VPHG may change the wavelength at which the peak diffraction efficiency of the VPHG occurs and the bandwidth of the VPHG.

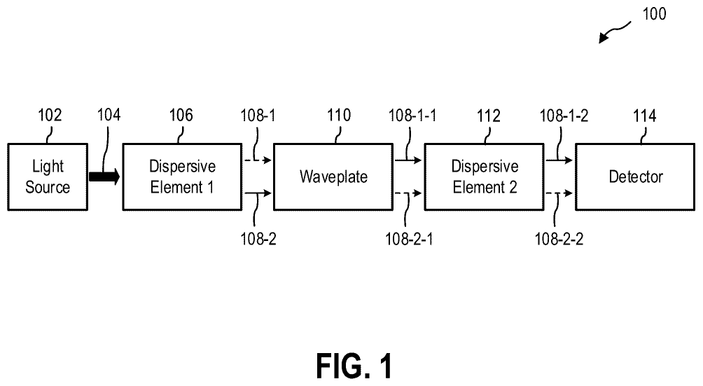

FIG. 1 is a representation of a schematic of a diffraction system 100, according to at least one embodiment of the present disclosure. A light source 102 may provide incident light 104. The light source 102 may be any type of light source. For example, the light source 102 may be a light source from a fiber optic cable. In some examples, the light source 102 may be a light source from a spectroscopy system. In some examples, the light source 102 may be any other type of light source.

The incident light 104 may interact with a first dispersive element 106, such as a diffraction grating. The first dispersive element 106 may disperse or separate the incident light 104 into at least two segments (collectively 108). A first light segment 108-1 may be a diffracted portion of the incident light 104. A second light segment 108-2 may be an undiffracted (or passed through) portion of the incident light 104.

In some embodiments, the dispersive element may have a higher diffraction efficiency for a first polarization (such as s-polarization) than a second polarization (such as a p-polarization). Thus, in some embodiments, the first light segment 108-1 may primarily have the first polarization, and the second light segment 108-2 may primarily have the second polarization. In FIG. 1, a light segment 108 having the first polarization as the primary polarization is indicated by a dotted line and a light segment having the second polarization as the primary polarization is indicated by a solid line.

The light segments 108 may then be passed through a waveplate 110. The waveplate 110 may rotate both light segments 108 90°, thereby changing their polarization. This may result in a rotated first light segment 108-1-1 and a rotated second light segment 108-2-1. As may be seen, the rotated first light segment 108-1-1 has switched polarization from the first polarization to the second polarization. Similarly, the rotated second light segment 108-2-1 has switched polarization from the second polarization to the first polarization.

The light segments 108 may then pass through a second dispersive element 112. The second dispersive element 112 may then diffract with a higher efficiency the rotated second light segment 108-2-1 having the first polarization (into a rotated diffracted second light segment 108-2-2) than the rotated first light segment 108-1-1 (which is diffracted into a rotated diffracted first light segment 108-1-2) having the second polarization. In this manner, a large portion, or the entirety, of the incident light 104 from the light source 102 may be diffracted. This may allow for more efficient and/or higher quality analysis when the light segments 108 are received at the detector 114.

In accordance with embodiments of the present disclosure, the diffraction system 100 may be utilized in spectroscopy systems. For example, in highly sensitive applications, such as in nuclear fusion reactors and power generation systems, the atomic emission lines of different isotopes and atoms may be very close together. Therefore, a high diffraction efficiency may allow more of the spectroscopy light to be analyzed. Furthermore, plasma generated during nuclear fusion application may be randomly polarized. Because the polarization of the emitted plasma is not consistently s or p-polarization, then a high diffraction efficiency in both s and p-polarization may reduce the amount of undiffracted light, thereby improving the amount of available light for analysis. This may help to increase the accuracy and/or precision of spectroscopy analysis. While the specific example of spectroscopy with respect to nuclear fusion has been provided, it should be understood that the principles of the present disclosure may provide similar benefits to spectroscopy in any other industry in which spectroscopy is used.

According to embodiments of the present disclosure, the diffraction system 100 may further be used in signal analysis of telecommunication systems. In some situations, telecommunication systems may determine system efficiency based on the least efficient portion of a system. For a diffraction grating that has a high diffraction efficiency in one polarization but a low diffraction efficiency in a second polarization, this may result in the diffraction grating having a reduced utilization and/or effectiveness in a telecommunication system. The systems and methods described herein may allow for an increased utilization of the diffraction grating in a telecommunication system, thereby increasing signal analysis and decoding efficiency.

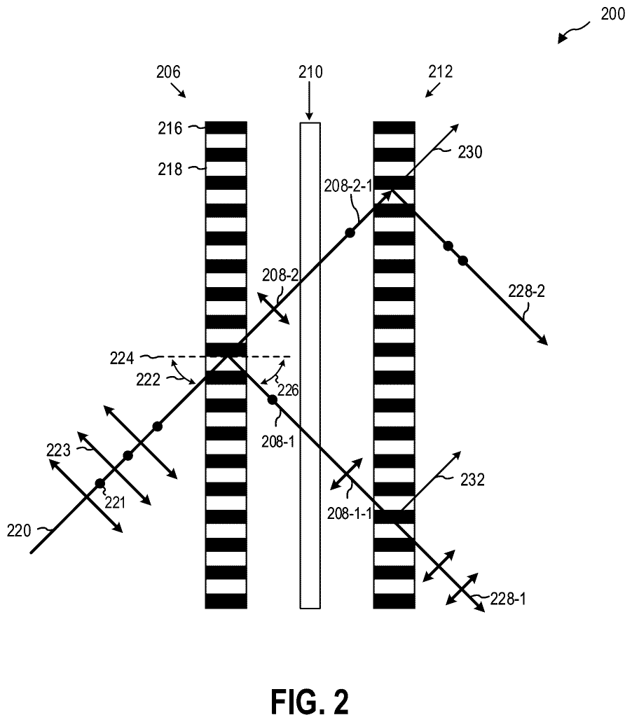

FIG. 2 is a representation of an exploded view of a diffraction system 200, according to at least one embodiment of the present disclosure. The diffraction system 200 includes a first diffraction grating 206 and a second diffraction grating 212. A waveplate 210 (or multiple waveplates, or any combinations of components or materials that rotate or modify the polarization of light) may be located between the first diffraction grating 206 and the second diffraction grating 212. In the following discussion, the properties described with respect to the first diffraction grating 206 may be applied to the second diffraction grating 212. In some embodiments, the first diffraction grating 206 may be identical to the second diffraction grating 212. However, it should be understood that differences in the properties discussed herein may exist between the first diffraction grating 206 and the second diffraction grating. For example, the first diffraction grating 206 and the second diffraction grating may differ in symmetry, index modulation, index modulation profile, diffraction efficiency, PDL, thickness, height, spatial frequency, wavelength of peak diffraction efficiency, any other property, and combinations thereof.

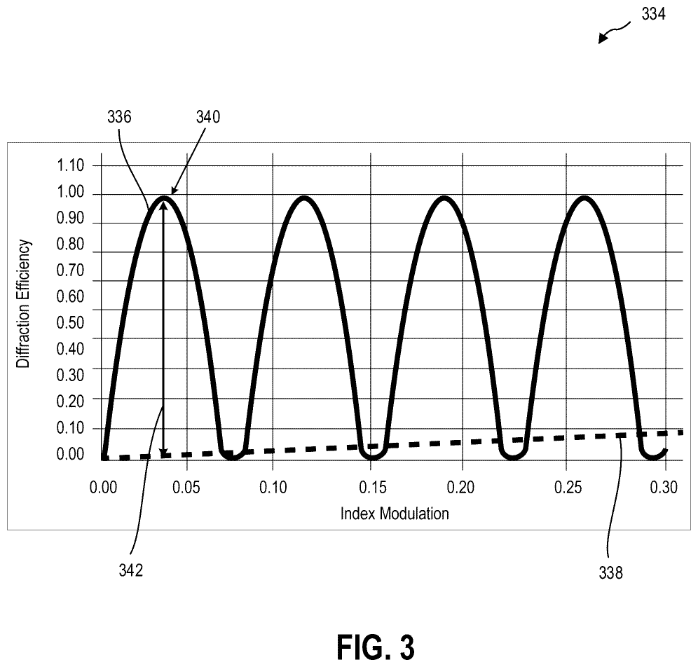

In the embodiment shown, the first diffraction grating 206 includes a plurality of Bragg planes 216. The Bragg planes 216 may have a higher index of refraction than a plurality of low-index regions 218 spaced between the Bragg planes 216. The Bragg planes 216 may allow the diffraction grating 206 to diffract light incident on the first diffraction grating 206. The first diffraction grating may have a bulk index and an index modulation. In the embodiment shown in FIG. 2, the first diffraction grating 206 and the second diffraction grating 212 are VPHGs. In a VPHG, the index modulation may vary, resulting in an index modulation profile (see, e.g., the index modulation profiles shown in FIG. 3). The index modulation profile may have a shape, such as a sinusoidal, a truncated sinusoidal, a square wave, or a different shape. The first diffraction grating 206 and/or the second diffraction grating 212 may further have a bulk index. The bulk index may be an average of the index of refraction of the Bragg planes 216 and the low-index regions 218.

The first diffraction grating 206 and/or the second diffraction grating 212 may have a spatial frequency. The spatial frequency may be a measure of a distance between Bragg planes 216. The spatial frequency may be a measure of how many pairs of high index of refraction regions (e.g., Bragg planes 216) and low index of refraction regions (e.g., low-index regions 218) are located in a millimeter long portion of the first diffraction grating 206 measured along a length of the first diffraction grating 206 (typically expressed in lines per millimeter, Ipmm, or I/mm). For example, the first diffraction grating 206 may have a spatial frequency of 905 I/mm. That may represent that the first diffraction grating includes 905 Bragg planes 216 and 905 low-index regions 218 along a millimeter length of the first diffraction grating 206.

In the embodiment shown in FIG. 2, incident light 220 may enter the first diffraction grating 206 at a point of incidence. An angle of incidence 222 may be an angle between the incident light 220 and a line 224 perpendicular to a surface of the first diffraction grating 206 at the point of incidence. The Bragg planes 216 may diffract the incident light 220. A center wavelength of the diffracted light may exit the first diffraction grating 206 at an angle of diffraction 226 relative to the line 224 perpendicular to a surface of the first diffraction grating 206. The Bragg planes 216 may further disperse light received at the angle of incidence 222 at a particular angle of dispersion.

As may be seen, the incident light 220 may include a plurality of different polarizations. For simplicity of illustration and discussion, and without limiting the disclosure, the incident light 220 shown includes s-polarized light 221 and p-polarized light 223.

The Bragg planes 216 may have an orientation (which may also be referred to as a tilt). In the embodiment shown, each of the Bragg planes 216 have an identical orientation. The Bragg planes 216 may be oriented such that the angle of diffraction 226 equals the angle of incidence 222. When the Bragg planes 216 are oriented such that the angle of diffraction 226 equals the angle of incidence 222, the first diffraction grating 206 (or the individual Bragg planes 216) may be referred to as symmetric. In some embodiments, the Bragg planes 216 may not diffract the incident light 220 with an angle of diffraction 226 that equals the angle of incidence 222, resulting in an asymmetric diffraction grating.

In some embodiments, the first diffraction grating 206 may include a total angle of diffraction. The total angle of diffraction may be the sum of the angle of incidence 222 and the angle of diffraction 226. As may be seen, if the first diffraction grating 206 is symmetric, then the total angle of diffraction may be determined by doubling the angle of incidence 222. If the first diffraction grating 206 is asymmetric, then the total angle of diffraction may be determined by adding the angle of incidence 222 to the angle of diffraction 226.

The first diffraction grating 206 has a diffraction efficiency. The diffraction efficiency of the first diffraction grating 206 may be a function of wavelength. In other words, the diffraction efficiency of the first diffraction grating may vary depending on a wavelength of the incident light 220. In some embodiments, a thickness of a medium of the first diffraction grating 206 may impact the diffraction efficiencies of the first diffraction grating 206.

Different applications and/or different light wavelengths may be handled at different total angles of diffraction. The diffraction efficiency in a particular application may be at least partially determined based on the total angle of diffraction. In some embodiments, the total angle of diffraction may change the modulation profile for s or p-polarization. For example, increasing the total angle of diffraction may decrease the diffraction efficiency of p-polarized light. This may result in a diffraction grating that may be optimized with a high diffraction efficiency for s-polarized light, but may have a low diffraction efficiency at any usable level of index modulation. This may increase the total PDL of an individual diffraction grating. Indeed, modifying the spatial frequencies and/or film thicknesses may result in a wide variety of index modulation curves.

In accordance with embodiments of the present disclosure, the first diffraction grating 206 may have one or more peak diffraction efficiencies. The one or more peak diffraction efficiencies may occur at one or more particular wavelengths. The first diffraction grating 206 may be specifically designed to have one or more characteristics that result in the first diffraction grating 206 having the one or more peak diffraction efficiencies at the one or more particular wavelengths. For example, the first diffraction grating 206 may be designed to have a peak diffraction efficiency at 1545 nm. In the alternative, the first diffraction grating 206 may be designed to have a peak diffraction efficiency at 720 nm, or any other wavelength. As discussed herein, the diffraction efficiency for a particular diffraction grating may be different for s-polarized light and p-polarized light.

The difference in diffraction efficiency between s-polarized light and p-polarized light is the polarization dependent loss (PDL). A low PDL may be an indication of a diffraction grating or a system where the diffraction efficiency between s-polarized light and p-polarized light is approximately the same. In some situations, a diffraction grating may have a high diffraction efficiency for s-polarized light and p-polarized light, resulting in a low PDL. In some applications of diffraction grating systems of the present disclosure, it may be desirable to have a low PDL so that a technician or other operator may analyze at least a sample of the both s-polarized light and p-polarized light of the incident light 220. In some embodiments, it may be desirable to have both a high diffraction efficiency and a low PDL so that a technician may analyze as much of the incident light as possible having both s-polarization and p-polarization.

The first diffraction grating 206 may have a bandwidth. The bandwidth of the first diffraction grating 206 may be a range of wavelengths for which the diffraction efficiency of the first diffraction grating 206 is greater than a threshold. For example, the bandwidth of the first diffraction grating 206 may be a set of wavelengths for which the PDL of the first diffraction grating 206 above 95%. In some embodiments, the bandwidth of the first diffraction grating 206 may depend on a thickness of a medium of the first diffraction grating 206. The first diffraction grating 206 may be designed to have one or more characteristics that result in the first diffraction grating 206 having a bandwidth that includes a particular set of wavelengths.

In accordance with embodiments of the present disclosure, when the incident light 220 passes into the first diffraction grating 206, the first diffraction grating 206 may separate the light into a first light segment 208-1 and a second light segment 208-2. The first light segment 208-1 may be a diffracted portion of the incident light 220. Put another way, the portion of the incident light 220 that is diffracted by the first diffraction grating 206 may be the first light segment 208-1. In the embodiment shown, the first diffraction grating has a high diffraction efficiency with respect to s-polarized light. Based on the high diffraction efficiency of the first diffraction grating 206 with respect to s-polarized light 221, the first light segment 208-1 consists primarily of s-polarized light 221 between the first diffraction grating 206 and the waveplate 210. Put another way, a majority of the first light segment 208-1 is s-polarized light.

The second light segment 208-2 may be the undiffracted light that is passed through the first diffraction grating 206. In the embodiment shown, the first diffraction grating 206 has a low diffraction efficiency for p-polarized light. Based on the diffraction efficiency of the diffraction grating 206 with respect to p-polarized light, the p-polarized light 223 of the incident light 220 may primarily pass through the first diffraction grating 206. Thus, the second light segment 208-2 consists primarily of p-polarized light 223 between the first diffraction grating 206 and the waveplate 210. Put another way, a majority of the second light segment 208-2 is p-polarized light.

After the incident light 220 is at least partially diffracted by the first diffraction grating 206, the separated portions of the incident light (collectively light segments 208) may pass through the waveplate 210. The waveplate 210 may rotate the light segments 208. In some embodiments, the waveplate 210 may be a half-wave plate. In some embodiments, a half-wave plate may rotate a light wave to change the polarity between s-polarization and p-polarization.

The waveplate 210 may rotate the first light segment 208-1 having primarily s-polarized light 221 to a rotated first light segment 208-1-1 having primarily p-polarized light 223. The rotated first light segment 208-1-1 may then travel to the second diffraction grating 212. In the embodiment shown, the second diffraction grating 212 has the same properties as the first diffraction grating 206. Thus, the second diffraction grating 212 has a low diffraction efficiency with respect to p-polarized light. Therefore, a large portion of the rotated first light segment 208-1-1 may pass through the second diffraction grating 212 undiffracted, resulting in a first detected light segment 228-1. The first detected light segment 228-1 may then travel to a detector (e.g., detector 114 of FIG. 1) or other collection apparatus for analysis.

The waveplate 210 may rotate the second light segment 208-2 having primarily p-polarized light 223 to a rotated second light segment 208-2-1 having primarily s-polarized light. The rotated second light segment 208-2-1 may then travel to the second diffraction grating 212. As discussed above, the second diffraction grating 212 shown has the same properties as the first diffraction grating 206. Thus, the second diffraction grating has a high diffraction efficiency with respect to s-polarized light. Therefore, a large portion of the rotated second light segment 208-2-1 may be diffracted by the second diffraction grating 212, resulting in a second detected light segment 228-2. The second detected light segment 228-2 may then travel to a detector or other collection apparatus for analysis. A portion of undiffracted light 230 may pass undiffracted through both the first diffraction grating 206 and the second diffraction grating 212. Further diffraction and/or collection equipment may be used to further analyze the undiffracted light 230.

The combined detected light segments (collectively 228) may represent a large portion of the original incident light 220. For example, consider an embodiment where the diffraction efficiency with respect to s-polarized light for the first diffraction grating 206 and the second diffraction grating 212 is 99%, the diffraction efficiency with respect to p-polarized light for the first diffraction grating and the second diffraction grating is 1%, and the proportion of s-polarized light 221 to p-polarized light 223 in the incident light 220 is 50/50, assuming no other efficiency losses in the system. In this situation, the first light segment 208-1 may include 50% of the incident light (e.g., 50% s-polarized light 221 multiplied by 99% (resulting in 49.5% s-polarized light) plus 50% p-polarized light multiplied by 1% (resulting in 0.5% p-polarized light)). The second light segment 208-2 may include 50% of the incident light 220 (e.g., the remaining portion of s-polarized light (0.5%) and the remaining portion of p-polarized light (49.5%)).

When the first light segment 208-1 passes through the waveplate 210, the polarizations may switch, leaving the rotated first light segment 208-1-1 with 49.5% p-polarized light and 0.5% s-polarized light of the total incident light 220. When the rotated first light segment 208-1-1 passes through the second diffraction grating 212, the first detected light segment 228-1 may include 49.005% p-polarized light (e.g., 49.5% minus 49.5% multiplied by 1% diffraction efficiency for p-polarized light) and 0.005% s-polarized light (e.g., 0.5% minus 0.5% multiplied by 99% diffraction efficiency for s-polarized light) of the total incident light 220. The remaining portions of the rotated first light segment 208-1-1 may be diffracted in a diffracted portion 232, including 0.495% s-polarized light and 0.495% p-polarized light, which totals 0.99% of the incident light 220.

When the second light segment 208-2 passes through the waveplate 210, the polarizations may switch, leaving the rotated second light segment 208-2-1 with 49.5% s-polarized light (of the total incident light 220) and 0.5% p-polarized light. When the rotated second light segment 208-2-1 passes through the second diffraction grating 212, the second detected light segment 228-2 may include 49.005% s-polarized light (e.g., 49.5% multiplied by 99% diffraction efficiency for s-polarized light) and 0.005% p-polarized light (e.g., 0.5% multiplied by 1% diffraction efficiency for p-polarized light) of the total incident light 220. The remaining portions of the rotated second light segment 208-2-1 may be the undiffracted light 230, including 0.495% p-polarized light and 0.495% s-polarized light, which totals 0.99% of the incident light 220.

As may be seen, the first detected light segment 228-1 and the second detected light segment 228-2 account for 98.02% of the total incident light 220. This may be considered the total collected light percentage of the diffraction system 200. Put another way, in the example provided, the total collected light percentage of the diffraction system 200 may be 98.02%. The undiffracted light 230 and the diffracted portion 232 account for approximately 1.98% of the total incident light 220. This may be considered the total uncollected light percentage of the diffraction system 200. Put another way, in the example provided, the total uncollected light percentage of the diffraction system 200 may be 1.98%. Decreasing the total uncollected light percentage of the diffraction system 200 may help to increase the sensitivity and/or effectiveness of the analysis of the detected light segments 228.

As may be understood, the total uncollected light percentage may be determined based on the diffraction efficiencies of the first diffraction grating 206 and the second diffraction grating 212. In some embodiments, the total uncollected light percentage may be in a range having an upper value, a lower value, or upper and lower values including any of 0.1%, 0.2%, 0.3%, 0.4%, 0.5%, 0.75%, 1.0%, 1.5%, 2.0%, 2.5%, 5%, 7.5%, 10%, 15%, 20%, 25%, 30%, 35%, 40%, 45%, 50%, 60%, 70%, 80%, 90%, 100% or any value therebetween. For example, the total uncollected light percentage may be greater than 0.1%. In another example, the total uncollected light percentage may be less than 100%. In yet other examples, the total uncollected light percentage may be any value in a range between 0.1% and 100%. In some embodiments, it may be critical that the total uncollected light percentage is less than 2% to increase the sensitivity and/or effectiveness of the diffraction system 200.

FIG. 3 is a representation of an index modulation profile 334 for a diffraction grating having 1175 I/mm and a total angle of diffraction of 130.4°, with the index modulation value on the horizontal axis and a diffraction efficiency on the vertical axis. The index modulation profile 334 shown includes a s-polarization profile 336 and a p-polarization profile 338.

As may be seen, the s-polarization profile 334 includes a plurality of diffraction efficiency peaks 340 at different index modulation values. The p-polarization profile 338 does not include any peaks. Indeed, the highest diffraction efficiency is approximately 10%. A conventional diffraction system utilizing this diffraction grating would have a low total efficiency rating based on the low overall diffraction efficiency of the p-polarization profile 338.

A diffraction grating may be tuned to one or more index modulations. In accordance with embodiments of the present disclosure, a diffraction system may be designed using a diffraction grating tuned to a diffraction efficiency peak 340. To decrease the total uncollected light percentage of a diffraction system, the diffraction gratings may be selected having a high individual PDL. Two diffraction gratings having individually high PDLs that are separated by a half-wave plate may result in a diffraction system having a low total uncollected light percentage. As discussed above with respect to FIG. 2, this may be because a diffraction grating having a low diffraction efficiency with respect to p-polarized light may allow a large amount of p-polarized light to pass through the diffraction grating. In the first diffraction grating, this may allow a large amount of the p-polarized light to pass through to be rotated by the waveplate and diffracted at the second diffraction grating. In the second diffraction grating, this may allow a large amount of the rotated light segment to pass through the second diffraction grating. In this manner, high individual PDLs in diffraction gratings of a diffraction system may result in a low total uncollected light percentage of the diffraction system.

In the embodiment shown in FIG. 3, a diffraction system may be designed using two identical diffraction gratings tuned to the first (e.g., leftmost, having the lowest index modulation) diffraction efficiency peak 340. As may be seen, a difference 342 between the peak 340 and the p-polarization profile 338 may be the location where the PDL of the diffraction grating may be maximized. Two diffraction gratings tuned to this particular peak 340 may have a low total uncollected light percentage.

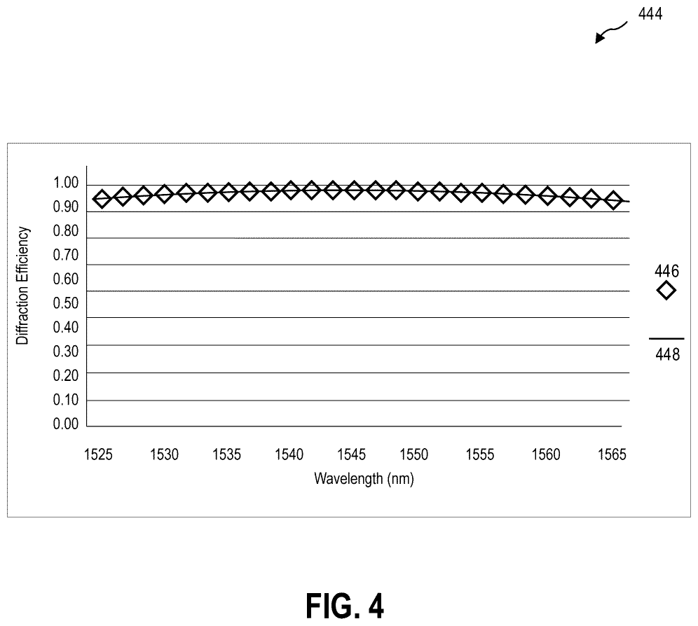

FIG. 4 is a representation of a diffraction efficiency curve 444 for a diffraction system across a bandwidth of wavelengths, with diffraction efficiency on the vertical axis and wavelength on the horizontal axis, according to at least one embodiment of the present disclosure. The diffraction efficiency curve 444 includes an s-polarization efficiency profile 446 and a p-polarization efficiency profile 448. As may be seen, there is little difference in efficiency between the s-polarization efficiency profile 446 and the p-polarization efficiency profile 448.

This may be a result of the structure of the diffraction system. The first diffraction grating may diffract s-polarized light with a high efficiency and p-polarized light with a low efficiency. When the light that passes through the first diffraction grating is rotated by the waveplate, the originally diffracted s-polarized light is rotated to p-polarized light and passed through the second diffraction grating. The p-polarization efficiency profile 448 may be a representation of the diffracted s-polarized light from the first diffraction grating that has been rotated to p-polarized light and passed through the second diffraction grating. Thus, before rotation, the p-polarization efficiency profile has effectively been diffracted with the diffraction efficiency of s-polarized light from the first diffraction grating.

The s-polarization efficiency profile 446 may be a representation of the p-polarized light that passed through the first diffraction grating, was rotated to s-polarized light, and then diffracted by the second diffraction grating. Thus, the s-polarization efficiency profile 446 represents the portion of the incident light that initially passed through the first diffraction grating without diffracting, and was eventually diffracted by the second diffraction grating. In this manner, both the p-polarization efficiency profile 448 and the s-polarization efficiency profile 446 may be light that was diffracted while in an s-polarization orientation.

A comparison of the s-polarization efficiency profile 446 and the p-polarization efficiency profile 448 may provide an indication of the total PDL of the system. Specifically, the gap between the s-polarization efficiency profile 446 and the p-polarization efficiency profile 448 may be the PDL of the diffraction system. In a situation where the first diffraction grating and the second diffraction grating are identical, the diffraction efficiency for both s-polarized light and p-polarized light is the same, leading to a very low PDL (e.g., less than 1%) for the system. In some embodiments, the system PDL may be in a range having an upper value, a lower value, or upper and lower values including any of 0.1%, 0.2%, 0.3%, 0.4%, 0.5%, 0.75%, 1.0%, 1.5%, 2.0%, 2.5%, 5%, 7.5%, 10%, 15%, 20%, 25%, 30%, 35%, 40%, 45%, 50%, or any value therebetween. For example, the system PDL may be greater than 0.1%. In another example, the system PDL may be less than 50%. In yet other examples, the system PDL may be any value in a range between 0.1% and 50%. In some embodiments, it may be critical that the system PDL is less than 1% to decrease system sensitivity to changes in polarization. In some embodiments, PDL may be quantified in dBs.

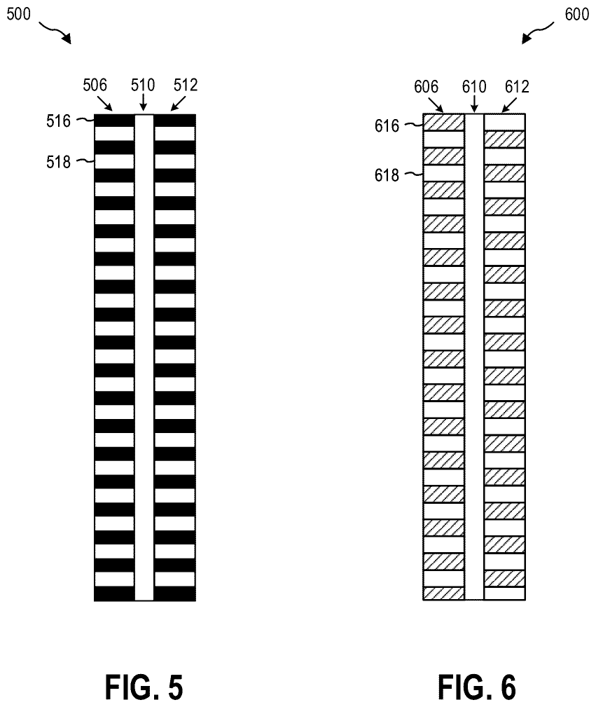

FIG. 5 is a representation of an assembled diffraction system 500, according to at least one embodiment of the present disclosure. The diffraction system 500 includes a first diffraction grating 506 and a second diffraction grating 512 separated by a waveplate 510. In the embodiment shown, the waveplate 510 is in contact with the first diffraction grating 506 and the second diffraction grating 512.

In some embodiments, the waveplate 510 may be connected to the first diffraction grating 506 and/or the second diffraction grating 512 with an adhesive. In some embodiments, the adhesive may be an optically transparent adhesive (e.g., an adhesive that has very low diffraction, diffusion, scattering, reflection, or other light scattering or light altering properties). In some embodiments, the adhesive may have known diffraction or other light altering properties. When designing the diffraction system 500, the properties of the adhesive may be taken into account when determining the diffraction properties of the diffraction system 500. In some embodiments, the adhesive may act as an index matching medium between the grating and the waveplate. In some embodiments, index matching or other fluids may be used that may perform other functions such as cooling the grating-waveplate-grating system

In some embodiments, the waveplate 510 may be connected to the first diffraction grating 506 and/or the second diffraction grating 512 with a mechanical connection. For example, a screw, bolt, latch, clamp, or other mechanical fastener may connect the waveplate 510 to the first diffraction grating 506 and/or the second diffraction grating 512. In some embodiments, the mechanical fastener may be connected the first diffraction grating 506, the waveplate 510, and the second diffraction grating 512 in a location that is outside of a clear aperture of the diffraction system 500. For example, incident light (e.g., incident light 220 of FIG. 2) that is directed to the diffraction system 500 may contact or engage the diffraction system inside of a capturing area. A fastener or other obstruction located outside of the capturing area may not obstruct or otherwise alter the path of the captured light. A mechanical fastener may connect the first diffraction grating 506, the waveplate 510, and/or the second diffraction grating 512 without an adhesive, thereby reducing or eliminating any optical disturbance caused by an adhesive. In some embodiments, the mechanical fastener may be utilized in combination with an adhesive.

In the embodiment shown in FIG. 5, the first diffraction grating 506 is identical to the second diffraction grating 512. For example, the Bragg planes 516 of the first diffraction grating 506 may have the same size, shape, thickness, width, depth, construction, index modulation, orientation, any other aspect of the Bragg planes 516, and combinations thereof as the Bragg planes 516 of the second diffraction grating 512. Similarly, the low-index regions 518 of the first diffraction grating 506 may have the same size, shape, thickness, width, depth, construction, index modulation, orientation, any other aspect of the low-index regions 518, and combinations thereof as the low-index regions 518 of the second diffraction grating 512.

However, in some embodiments, the first diffraction grating may be different from the second diffraction grating. For example, FIG. 6 shows a representation of a diffraction system 600 in which a first diffraction grating 606, which is separated from a second diffraction grating by a waveplate 610, is different from the second diffraction grating 612. In the embodiment shown, the spatial frequency of the first diffraction grating 606 is different than the second diffraction grating 612 (illustrated in FIG. 6 by offsetting the Bragg planes 616 and the low-index regions 618 between the first diffraction grating 606 and the second diffraction grating 612). This may alter the light path of the light diffracted from the second diffraction grating 612.

It should be understood that any other property of the first diffraction grating 606 may be different than the second diffraction grating 612. For example, the size, shape, thickness, width, depth, construction, index modulation, orientation, spatial frequency, any other aspect of the Bragg planes 616, and combinations thereof may be different between the first diffraction grating 606 and the second diffraction grating 612. In some examples, the size, shape, thickness, width, depth, construction, modulation index, spatial frequency, any other aspect of the low-index regions 618 may be different between the first diffraction grating 606 and the second diffraction grating 612.

Different properties between the first diffraction grating 606 and the second diffraction grating 612 may allow for the light segments to be modified differently in the second diffraction grating 612. This may allow a technician or other operator to tailor the design of the diffraction system 600 to a particular application. In some embodiments, different properties in the first diffraction grating 606 and the second diffraction grating 612 may allow the diffraction system 600 to be used in different applications, such as in a dual-resolution spectrometer or other application that may analyze two different segments of light generated from the same incident light.

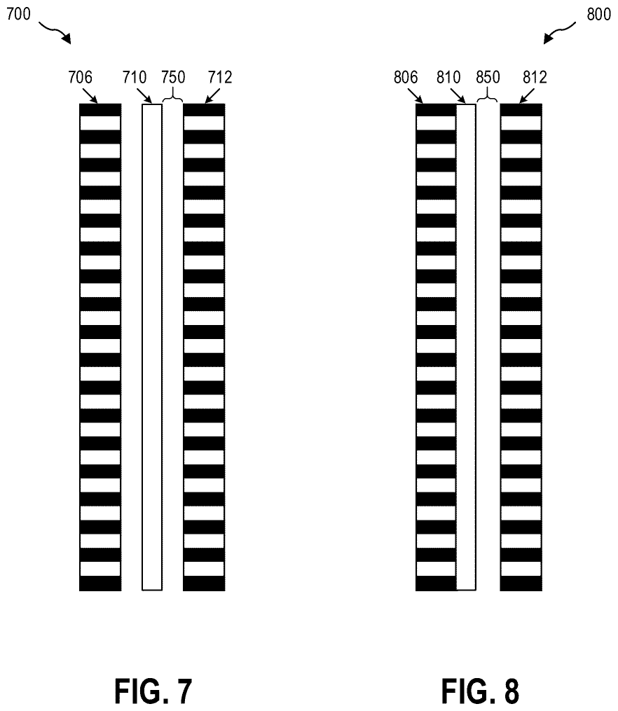

FIG. 7 is a representation of a diffraction system 700 in which a first diffraction grating 706 and a second diffraction grating 712 are separated or offset from a waveplate 710 by a gap 750, according to at least one embodiment of the present disclosure. As may be seen, the first diffraction grating 706 and the second diffraction grating 712 may not be directly connected to the waveplate 710. In some embodiments, the waveplate 710 may be rotated to change the diffraction efficiency of the system. In some embodiments, the gap 750 may be an air gap. The gap 750 may be filled with a gaseous medium, such as atmospheric air, or a constructed mix of gas, such as nitrogen, oxygen, helium, any other gas, and combinations thereof.

In some embodiments, the diffraction system 700 may be housed in a housing. The housing may be a pressurized housing. The pressurized housing may be pressurized to a specific pressure, such as a pressure that is lower than the atmospheric pressure. In some embodiments, no material may be located in the gap 750. For example, the gap 750 may include a vacuum.

In some embodiments, the gap 750 may be filled with a fluid. For example, the gap 750 may be filled with an optically transparent fluid. In some embodiments, the entire diffraction system 700 may be submerged in a fluid. In some embodiments, the fluid may include a liquid crystal.

FIG. 8 is a representation of a diffraction system 800 in which a waveplate 810 is connected to a first diffraction grating 806 and separated or offset from a second diffraction grating 812 by a gap 850, according to at least one embodiment of the present disclosure. This may allow the technician or other operator further control over the path of the light segments that have traveled through the first diffraction grating 806. As may be seen in a comparison between FIG. 5 through FIG. 8, diffraction systems in accordance with the present disclosure may have any construction or construction combinations to achieve any desired properties.

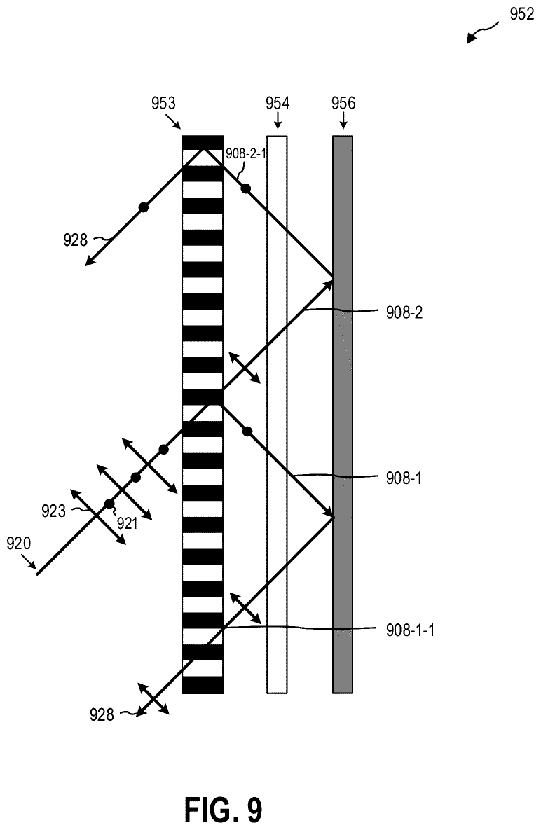

FIG. 9 is a representation of a diffraction system 952 including a single diffraction grating 953, according to at least one embodiment of the present disclosure. Incident light 920, including both s-polarized light 921 and p-polarized light 923, may be directed toward the diffraction grating 953. As discussed herein, the diffraction grating 953 may have a high diffraction efficiency for s-polarized light 921 and a low diffraction efficiency for p-polarized light 923. When the incident light 920 passes through the diffraction grating 953, the diffraction grating 953 may diffract a first segment 908-1 of the incident light 920 having primarily the s-polarized light 921. A second segment 908-2 may pass through the diffraction grating 953 without diffraction having primarily the p-polarized light.

The light segments (collectively 908) may pass through the waveplate 954, contact a mirror 956, and be reflected back to the waveplate 954. In some embodiments, the mirror 956 may be located opposite the diffraction grating 953 across the waveplate 954 that reflects light back to the diffraction grating 953. In the embodiment shown, the waveplate 954 may be a quarter-wave plate. Because the light segments 908 are passed through the quarter-wave waveplate 954 twice, the quarter-wave waveplate 954 may act as a half-wave plate, and change the polarity of the light segments 908 between s-polarized light 921 and p-polarized light 923.

In this manner, after the first light segment 908-1 has passed through the waveplate 954, been reflected off the mirror 956, and passed back through the waveplate 954, the first light segment 908-1 may be a rotated first light segment 908-1-1 having p-polarized light 923. Thus, the rotated first light segment 908-1-1 may pass through the diffraction grating 953 with a low diffraction efficiency.

After the second light segment 908-2 has passed through the waveplate 954, been reflected off the mirror 956, and passed back through the waveplate 954, the second light segment 908-2 may be a rotated second light segment 908-2-1 having primarily s-polarized light 921. When the rotated second light segment 908-2-1 passes through the diffraction grating, the rotated second light segment 908-2-1 may be diffracted with a high diffraction efficiency.

Thus, as may be seen, the diffraction system 952 shown in FIG. 9 may result in collected light 928 that is reflected back toward the light source of the incident light 920. In some embodiments, the collected light 928 may be reflected onto the light source. In some embodiments, the mirror 956 may be slanted or otherwise oriented to direct the collected light 928 away from the light source.

The diffraction system 952 may allow a technician or other operator to collect the light on the same side as the slight source of the incident light 920 using a light detector. Put another way, the light detector may be located on the same side as the incident light source. In some embodiments, a mirror 956 may be cheaper than a second diffraction grating, thereby reducing the cost of the diffraction system 952. Furthermore, a mirror 956 may be smaller than a second diffraction grating, thereby reducing the overall size of the diffraction system 952.

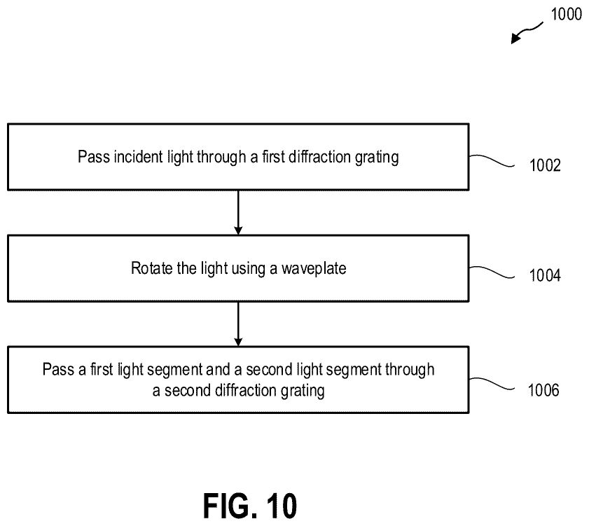

FIG. 10 is a representation of a method 1000 for light diffraction, according to at least one embodiment of the present disclosure. The method 1000 includes passing 1002 incident light through a first diffraction grating. The first diffraction grating diffracts a first portion of the incident light and passes a second portion of the incident light through the first diffraction grating undiffracted. The first diffraction grating has a first diffraction efficiency with respect to a first polarization and a second diffraction efficiency with respect to a second polarization. The first diffraction efficiency may be higher than the second diffraction efficiency, which may be represented by the PDL.

In some embodiments, the grating PDL may be in a range having an upper value, a lower value, or upper and lower values including any of 20%, 30%, 40%, 50%, 60%, 70%, 80%, 90%, 95%, 96%, 97%, 98%, 99%, 99.5%, 99.6%, 99.7%, 99.8%, 99.9%, or any value therebetween. For example, the grating PDL may be greater than 20%. In another example, the grating PDL may be less than 99.9%. In yet other examples, the grating PDL may be any value in a range between 20% and 99.9%. In some embodiments, it may be critical that the grating PDL is greater than 99% to increase the accuracy and/or precision of the sensor or other instrument to which the diffraction is connected.

The method further includes rotating 1002 the first portion of light and the second portion of light using a waveplate. This may change the polarization of the first portion of light and the second portion of light. The rotated first portion of light may then be passed 1006 through a second diffraction grating. The rotated second portion of light may then be passed 1008 through the second diffraction grating as well.

In some embodiments, when the first diffraction efficiency is significantly larger than the second diffraction efficiency (e.g., when the grating PDL is high), the rotated first portion of light (that was diffracted by the first diffraction grating) may pass through the second diffraction grating largely undiffracted (e.g., a large portion of the rotated second portion of the light may be diffracted by the second diffraction efficiency). A large portion of the rotated second portion of light (that passed undiffracted through the first diffraction grating) may be diffracted by the second diffraction grating with the first diffraction efficiency.

In this manner, a large portion of the incident light may be highly diffracted with a very low total system PDL. This may allow for a higher system efficiency and/or sensitivity.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The described embodiments are to be considered as illustrative and not restrictive, and the present disclosure may be embodied in other forms besides those specifically described herein. The scope of the disclosure is, therefore, indicated by the appended claims rather than by the foregoing description. Changes that come within the meaning and range of equivalency of the claims are to be embraced within their scope.

What is claimed is:

1. A diffraction grating system, comprising:
a first diffraction grating having a first diffraction efficiency in a first polarization and a second diffraction efficiency in a second polarization, wherein the first diffraction efficiency is higher than the second diffraction efficiency;
a second diffraction grating; and
a polarization rotation medium located between the first diffraction grating and the second diffraction grating, the polarization rotation medium being configured to rotate light passed through the first diffraction grating between the first polarization and the second polarization.

2. The system of claim 1, wherein the first diffraction grating is identical to the second diffraction grating.

3. The system of claim 1, wherein the first diffraction efficiency is greater than 99%.

4. The system of claim 1, wherein a system polarization dependent loss of the system is less than 1%.

5. The system of claim 1, wherein a grating polarization dependent loss of the first diffraction grating is greater than 95%.

6. The system of claim 1, wherein the polarization rotation medium is connected to the first diffraction grating with an adhesive.

7. The system of claim 1, wherein the polarization rotation medium is offset from at least one of the first diffraction grating or the second diffraction grating.

8. The system of claim 7, wherein a gap between the polarization rotation medium and the first diffraction grating is filled with a fluid.

9. The system of claim 1, wherein the first diffraction grating is formed from a volume phase holographic grating.

10. The system of claim 1, wherein the first diffraction grating includes one or more surface relief structures.

11. A method for light diffraction, comprising:
passing an incident light through a first diffraction grating, wherein the first diffraction grating has a first diffraction efficiency with respect to a first light polarization and a second diffraction efficiency with respect to a second light polarization, wherein passing the incident light through the first diffraction grating includes:
diffracting a first light segment of the incident light with the first diffraction grating;
passing a second light segment of the incident light through the first diffraction grating undiffracted;
rotating the first light segment and the second light segment through a waveplate such that a polarization of the first light segment and the second light segment is changed; and
passing the first light segment and the second light segment through a second diffraction grating.

12. The method of claim 11, wherein passing the first light segment through the second diffraction grating includes passing the first light segment through the second diffraction grating largely undiffracted.

13. The method of claim 11, wherein passing the second light segment through the second diffraction grating includes diffracting a large portion of the second light segment with the first diffraction efficiency.

14. The method of claim 11, wherein the waveplate is a half-wave plate.

15. The method of claim 11, further comprising collecting at least 98% of the incident light at a detector.

16. The method of claim 11, wherein the first diffraction grating is identical to the second diffraction grating.

17. A diffraction system, comprising:
an incident light source;
a diffraction grating having first diffraction efficiency in a first polarization plane and second diffraction efficiency in a second polarization plane, wherein the first diffraction efficiency is greater than the second diffraction efficiency; a waveplate that rotates light passed through the diffraction grating;
a mirror located opposite the diffraction grating across the waveplate that reflects light back to the diffraction grating; and
a light detector.

18. The diffraction system of claim 17, wherein the diffraction grating is asymmetric.

19. The diffraction system of claim 17, wherein the light detector is located on the same side of the waveplate as the diffraction grating.

20. The diffraction system of claim 17, wherein the waveplate is a quarter-wave plate.
